(19) United States
(12) Patent Application Publication
(10) Pub. No.: US 2007/0190486 A1
(43) Pub. Date: Aug. 16, 2007

(54) Dental instrument with light

(75) Inventor: Moshe Khaimov, Petach-Tikva (IL)

Correspondence Address: Stephen E. Feldman, 12 East 41st Street, New York, NY, 10017, US

(73) Assignee: DELDENT, LTD

(21) Appl. No.: 11/352,114

(22) Filed: Feb. 10, 2006

(51) Int. Cl. A61C 3/03

(52) U.S. Cl. 433/119

(57) ABSTRACT

An ultrasonic dental insert having at least one light source. A first transducer generates ultrasonic vibrations. A connecting body has a proximal end and a distal end having a tip attached thereto. The proximal end is attached to the first transducer so as to receive the ultrasonic vibrations therefrom and to transmit the ultrasonic vibrations toward the tip attached to the distal end. A second transducer is disposed substantially proximate to the connecting body for generating a voltage signal in response to movement of a portion of the connecting body according to the ultrasonic vibrations. At least one light source substantially proximate to the tip is connected to and receives the voltage signal from the second transducer to generate light. The ultrasonic dental insert may be inserted into a handpiece for providing electromagnetic energy to the first transducer to generate the ultrasonic vibrations.

### BACKGROUND

Dental practitioners use ultrasonic dental tools (instruments) for dental treatments and procedures, such as scaling, periodontal treatments, root canal therapy, and the like. An ultrasonic dental tool typically includes a handpiece coupled at one end (i.e., a proximal end) to an electrical energy source and a fluid source via a cable. The cable includes a hose to provide a fluid (e.g., water), and conductors to provide electrical energy.

The other end (i.e., a distal end) of the handpiece has an opening intended to receive a replaceable insert with a transducer (e.g., a magnetostrictive transducer) carried on the insert. The transducer extends from a proximal end of the insert into a hollow interior of the handpiece. An ultrasonically vibrated tip extends from a distal end of the insert.

Since a mouth is a small space in which to work, it is often difficult to see well into all regions of the mouth under the best of conditions. When a dental practitioner cannot see clearly in the field of work, it is more likely that painful slips can occur. The often sharp implements, vibrating at ultrasonic frequencies, can do considerable harm to soft tissue (such as gum tissue) resulting in bleeding and pain.

The large and focused lamp that hangs over the field of work while the dental practitioner uses ultrasonic dental tools in the patient's mouth often becomes obscured when the dental practitioner leans closely toward the patient to work in confined spaces within the mouth. The suddenly darker field is more difficult in which to work accurately. Small slips and injuries can result.

Therefore, it is desirable to provide an ultrasonic dental tool that can bring light directly into the field of work (i.e., patient's mouth). If such light can be provided using a source of energy already available in existing ultrasonic dental tools, circuit complexity and energy requirements can be reduced.

### SUMMARY

In an exemplary embodiment of the present invention, an ultrasonic dental insert has at least one light source. The ultrasonic dental insert includes a first transducer for generating ultrasonic vibrations. The ultrasonic dental insert also includes a connecting body having a proximal end and a distal end having a tip attached thereto. The proximal end is attached to the first transducer so as to receive the ultrasonic vibrations therefrom and to transmit the ultrasonic vibrations toward the tip attached to the distal end.

A second transducer is disposed on the insert, substantially proximate to the connecting body and generates a voltage signal in response to movement of a portion of the connecting body according to the ultrasonic vibrations. At least one light source substantially proximate to the tip is connected to and receives the voltage signal from the second transducer to generate light.

The ultrasonic dental insert may be inserted into a handpiece for providing electromagnetic energy to the first transducer to generate the ultrasonic vibrations, to form an ultrasonic dental tool having a light source.

In another exemplary embodiment of the present invention, a method of generating light used during dental procedures is provided. Ultrasonic vibrations are generated using a first transducer attached to a proximal end of a connecting body having a proximal end and a distal end having a tip attached thereto. The ultrasonic vibrations are transmitted through the connecting body toward the tip attached to the distal end of the connecting body. A voltage signal is generated using a second transducer disposed along the insert, substantially proximate to the connecting body in response to the movement of a portion of the connecting body according to the ultrasonic vibrations. The light is emitted from at least one light source substantially proximate to the tip and connected to the second transducer using the voltage signal.

In yet another exemplary embodiment of the present invention, a method of illuminating a work region is provided. Mechanical energy is received at a generator, said generator being mechanically supported by a tool handle, said tool handle being adapted to support an ultrasonic tool tip. The mechanical energy is converted to electromagnetic energy, and a work region is illuminated using at least a portion of said electromagnetic energy.

In still another exemplary embodiment of the present invention, a method of cleaning a tooth surface is provided. An ultrasonic signal is received at a dental tool handpiece. The ultrasonic signal is converted to an ultrasonic motion of a connecting body supporting a dental tool tip. The ultrasonic motion of said connecting body is coupled to an electrical generator. An electrical current is generated with said electrical generator. At least one light source is energized with said electrical current. The dental tool tip is contacted to a surface of a tooth. The surface of a tooth adjacent said dental tool tip is illuminated with said light source.

### BRIEF DESCRIPTION OF THE DRAWINGS

These and other aspects of the invention may be understood by reference to the following detailed description, taken in conjunction with the accompanying drawings, wherein:

FIG. 1 illustrates an ultrasonic dental unit (or system) including an ultrasonic dental tool attached to an electrical energy & fluid source;

FIG. 2 is a top view of a dental tool insert having an integrated light source in an exemplary embodiment of the present invention;

FIG. 3 is a side view of the dental tool insert of FIG. 2, which has been rotated by approximately 90 degrees from the top view depicted in FIG. 2;

FIG. 4 illustrates a tip for the dental tool insert of FIG. 2;

FIG. 5 illustrates the tip of FIG. 4, which has been rotated by approximately 90 degrees;

FIG. 6 is a cross-sectional view of the dental tool insert of FIG. 2, taken along the line 6-6;

FIG. 7 is an exploded perspective view of the dental tool insert of FIG. 2;

FIG. 8 is a flow diagram illustrating a method of illuminating a work region using the ultrasonic dental tool in exemplary embodiments of the present invention.

### DETAILED DESCRIPTION

In exemplary embodiments of the present invention, an ultrasonic dental insert has at least one integrated light source such as a light emitting diode (LED) that enables a dental practitioner to cast light on the work field while applying a tool to the teeth. The light source is energized by the already available ultrasonic vibrational energy such that an additional source of energy is not needed. By way of example, a transducer such as and/or including an illumination energy coil is provided and attached to the light source such that the light source is energized using vibrational energy converted by the transducer. By way of example, as the connecting body of the dental insert moves rapidly, an alternating current (ac) voltage is generated in the illumination energy coil, which is connected in series with the light source (e.g., light emitting diode (LED)) to provide energy for light emission. In other embodiments, any other suitable transducer for converting vibrational energy to an energy for light emission may be used. The word “light source” as used herein can include one or more than one light source(s).

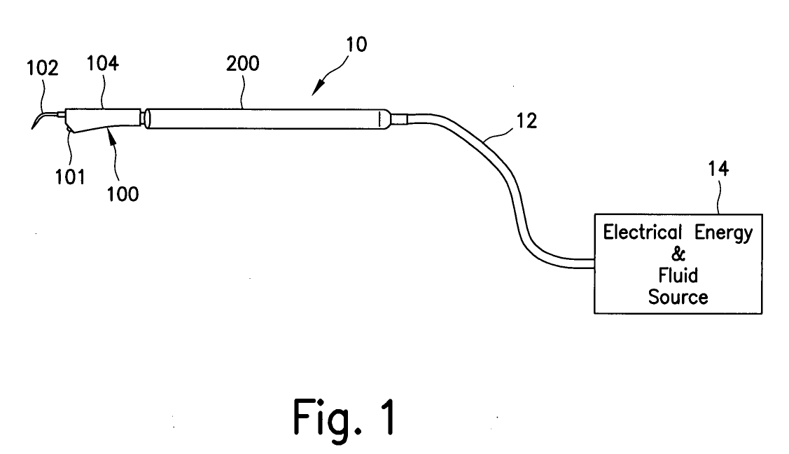

FIG. 1 illustrates an ultrasonic dental unit including an ultrasonic dental tool 10 attached to an electrical energy & fluid source 14 via a cable 12. The cable 12 includes a conduit for carrying fluid as well as wires for carrying electrical signals from the electrical energy & fluid source 14 to the ultrasonic dental tool 10. The ultrasonic dental tool 10 includes a handpiece 200 and an insert 100 inserted into the handpiece 200. It can be seen in FIG. 1 that a light source 101 has been integrated with the insert 100 near its distal end, substantially proximate to a tip 102.

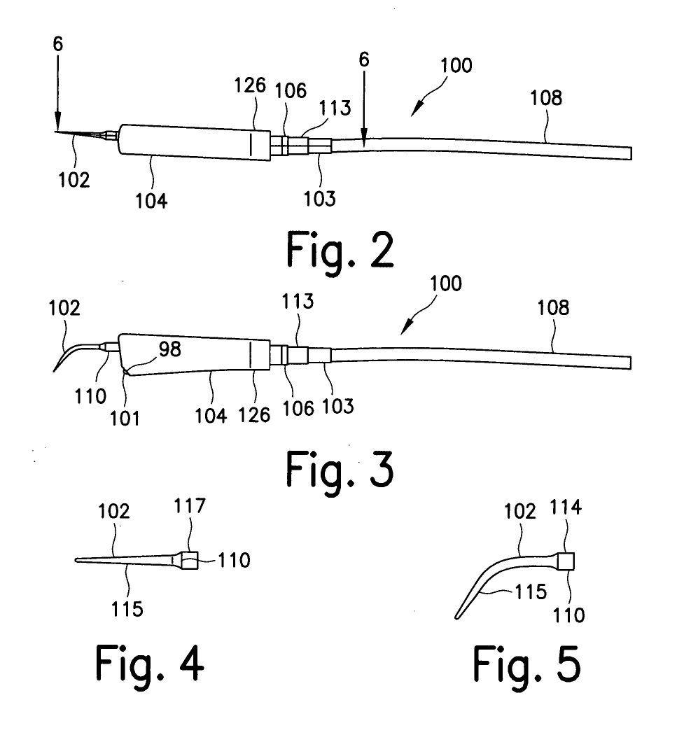

Referring now to FIGS. 2 and 3, the dental insert 100 includes the tip 102 at its distal end and an ultrasonic transducer 108 at its proximal end. The tip 102 is coupled to the transducer 108 via a connecting body 103, which may take the form of a shaft. The tip 102 may be removably attached to the connecting body 103 so that tips can be interchanged depending on the desired application. Further, the tip 102, when removed, may be disposed or steam autoclaved, or otherwise sterilized, after detaching it from the rest of the ultrasonic dental insert. The tip may also be made of metal or metallic alloys such as stainless steel.

The connecting body 103 is made of material suitable for transmitting ultrasonic vibrations such as stainless steel. The connecting body 103 is used to deliver ultrasonic vibrations generated by the transducer 108 to the tip 102. The transducer 108, for example, may be attached to the connecting body 103 by soldering, welding, laser welding and/or any other suitable method.

The connecting body 103 has mounted thereon an annular retaining tube 113, which has a generally cylindrical cavity formed therein for receiving a corresponding portion of the connecting body 103. This retaining tube is fixedly attached to the connecting body 103 such that it neither rotates nor moves laterally along the axis of the connecting body.

The ultrasonic dental insert 100 also includes the hand grip 104. The hand grip 104 has a generally cylindrical shape, and is fitted over the illumination energy bobbin 126 and secured in place. The hand grip 104 also has an opening 98 on one side at the end of which the light source 101 (e.g., LED) is disposed. The retaining tube 113 also has an O-ring 106 mounted thereon for engaging and pressing against the inner surface of the handpiece 200 so as to form a water tight seal.

The tip 102 can be in the form of a scaler, an endodontic dental file, a drill, or those useful for other periodontal or surgical treatments. The tip can also be made of metal or plastic. Some of them can also have a capability of delivering fluid and/or air.

The retaining tube 113 has an opening 112 formed thereon for receiving fluid from the handpiece 200. The fluid may exit through a linear groove (e.g., a passageway) 110 that is formed on the tip 102 for delivering fluid (e.g., water) and/or air to the gum or tooth of the patient.

During operation, the transducer 108 (which may be a stack of nickel plates) vibrates at a frequency equal to the natural frequency responsive to excitation induced by coils of the handpiece 200. After the insert is placed in the handpiece and the electrical energy source is powered on, the operator manually tunes the frequency of the electrical energy source until it reaches the resonance frequency, i.e., the natural frequency of the insert. Alternatively, auto-tune units may automatically lock on the insert resonance frequency once powered on. At this time, the transducer begins vibrating. This vibration of the stack is amplified and transmitted to the tip 102 through the connecting body 103. Any means of amplification are contemplated. Ultrasonic inserts used in the United States are typically designed to vibrate at 25 kHz or 30 kHz frequencies.

In response to the ultrasonic vibration of the stack, the tip 102 of the connecting body 103 vibrates (e.g., rapid back and forth motion in the direction of the axis of the connecting body 103). By way of example, the motion in the direction of the axis may be between 0.00125 centimeter (cm) to 0.00375 cm depending on such factors as the vibration frequency, material used for the connecting body 103, the length of the connecting body 103, and the like.

Referring now to FIGS. 4 and 5, the tip may have an elongated tapered portion 115, and a cylindrical interface portion 114 (“base”). It can be seen in FIG. 5 that the tapered portion 115 may be curved. The tapered portion 115 may have a circular cross section whose diameter decreases gradually from the end abutting the interface portion 114 (“the proximal end”) to the other end of the tip (“the distal end”). The distal end is applied to the gum/teeth or other patient tissues during the dental procedures.

It can be seen in FIG. 4, that the cylindrical interface portion 114 has the linear groove 110 formed in the direction of the axis of the insert 100. The fluid traveling through the illumination energy bobbin 126 exits through the linear groove 110 in the described embodiment. In other embodiments, the tip may have a small passageway therethrough for supplying water or other fluid to the region in the mouth being operated on, in which case a seal is provided between the bobbin 126 and the body 103.

The tip 102 may be formed as a single integrated piece with the connecting body 103. In other embodiments, the tip may be removable. For example, the tip may have attached to the interface portion a threaded portion for engaging a threaded opening formed on the connecting body. Using such threaded engagement, the tip may be made removable. Such removability would allow the tip to be a disposable tip that is replaced after a single patient use.

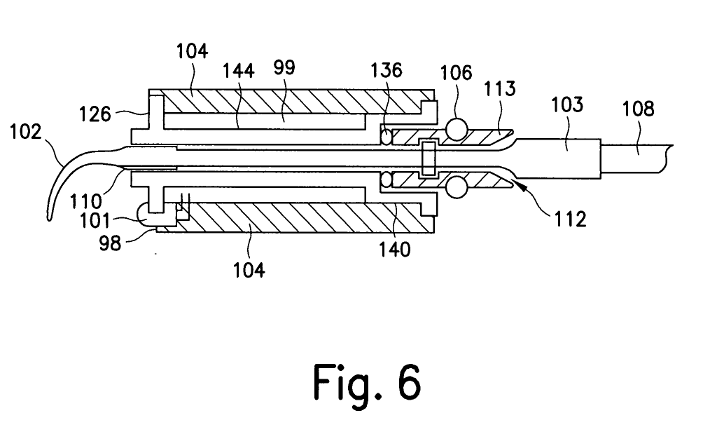

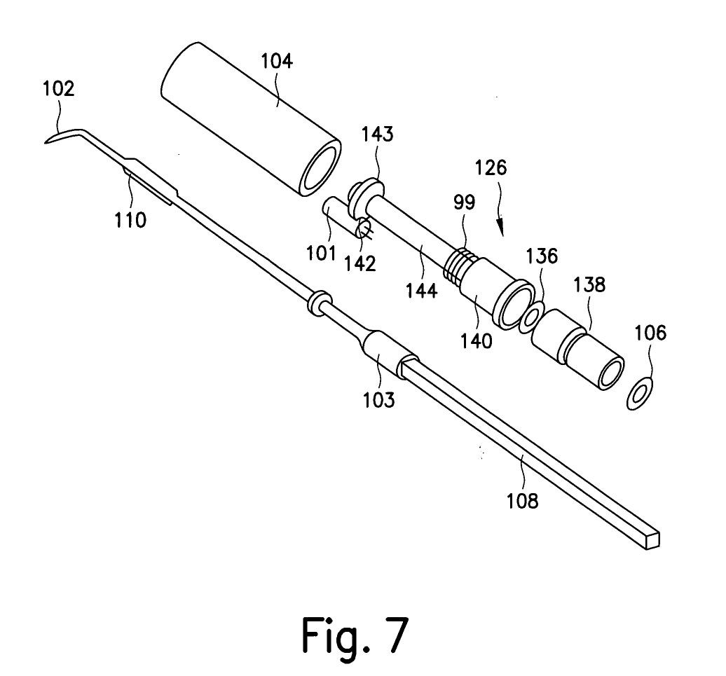

Referring now to FIGS. 6 and 7, an O-ring 136 is located between the retaining tube 113 and the bobbin 126. When the illumination energy bobbin 126 is mounted on the retaining tube 113, the O-ring 136 provides a seal between the retaining tube 113 and the illumination energy bobbin 126 so as to prevent undesired fluid leakage. The illumination energy bobbin 126 may be formed as one-piece, and may be slid onto and snap/pressure fit to the retaining tube 113.

The retaining tube 113 of the illustrated embodiment is locked to the connecting body 103, and neither rotates nor moves laterally with respect to the same. This can be achieved by constructing the retaining tube 113 in two parts and welding them together over the connecting body 103, or any other mechanical means.

It can be seen in FIGS. 6 and 7 that the illumination energy coil 99 is wound around the illumination energy bobbin 126, which is mounted in a surrounding relationship with the connecting body 103. The amount of voltage generated in the illumination energy coil 99 depends on such factors as the number of coil turns, the location of the illumination energy coil 99 with respect to the connecting body 103, the speed and frequency of the connecting body movement, the material used for the connecting body, and the like.

It can be seen in FIGS. 6 and 7 that the illumination energy bobbin 126 has formed thereon a seat 142 for mounting the LED 101 thereon. Further, the illumination energy bobbin 126 has formed thereon a flange 143 and a generally cylindrical section 144, on which the illumination energy coil 99 is mounted.

The illumination energy bobbin 126 has formed thereon away from the cylindrical section 144 a connecting portion 140 which envelops the portion of the retaining tube 113. In the described embodiment, the fluid enters the retaining tube 113 through the opening 112, and exits the illumination energy bobbin 126 via the groove 110 in the tip 102.

FIG. 15 illustrates illuminating a work region such as the mouth of a patient using the ultrasonic dental tool according to exemplary embodiments of the present invention. First, mechanical energy is received at a generator (e.g., the illumination energy coil 99). The generator is mechanically supported by a tool handle (e.g., the handpiece 200). The tool handle is adapted to support an ultrasonic tool tip (e.g., the tip 102). Accordingly, an electrical energy is received at an input of an electromagnetic transducer (e.g., the handpiece coil 238) (320). A magnetic field is formed within the electromagnetic transducer (322). The magnetic field moves an electromechanical transducer, e.g., the ultrasonic transducer 108, using the magnetic field (324). By moving an input member, e.g., the connecting body 103, of the generator with the electromechanical transducer, the generator receives the mechanical energy (326). Moving the input member may involve reciprocating the input member at a frequency of from about 25 kHz to about 30 kHz.

The mechanical energy is converted to electromagnetic energy (328). To achieve this, a magnetized member, e.g., the connecting body 103, is moved past an electrical coil 99, which may include at least one helically-wound electrical conductor. Such moving of the magnetized member may include vibration of the magnetized member in a substantially linear motion.

At least a portion of the electromagnetic energy thus generated is used to illuminate the work region (330). When converting the mechanical energy to electromagnetic energy to illuminate the work region, an electrical energy may first be generated using the generator. Then the electrical signal is received through an electrical conductor at an input of a light source, which may be an LED or an incandescent lamp (e.g., halogen light bulb). Using the electrical energy, visible light is emitted from the light source.

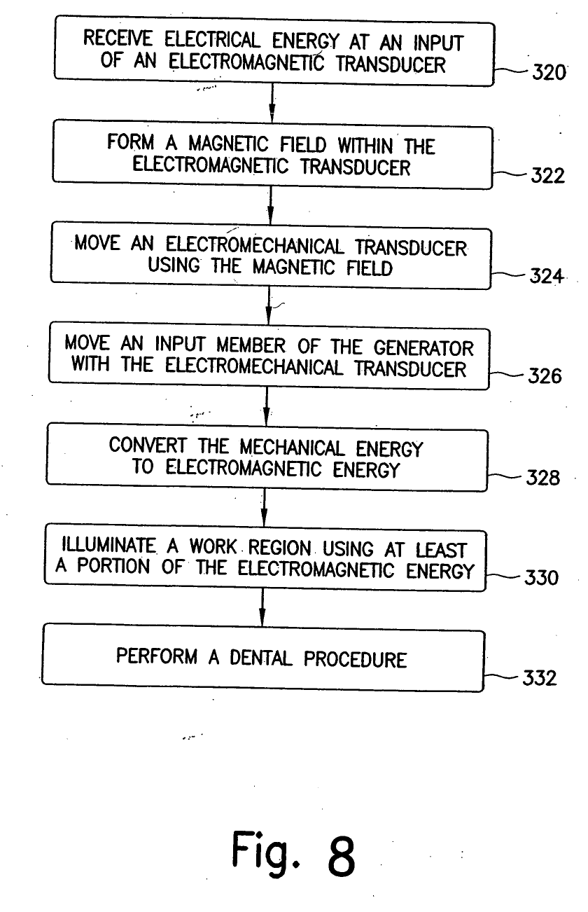

As shown in FIG. 8, with the illumination, a dental procedure may be performed using the tool handle (332). During the dental procedure, by way of example, a tooth is contacted with a tool tip, which is mechanically coupled to the tool handle, such that a surface of the tooth is disposed within the work region.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

We claim:

1. An ultrasonic dental insert comprising:
a first transducer for generating ultrasonic vibrations;
a connecting body having a proximal end and a distal end having a tip attached thereto, the proximal end attached to the first transducer so as to receive the ultrasonic vibrations therefrom and to transmit the ultrasonic vibrations toward the tip attached to the distal end;
a second transducer disposed substantially proximate to the connecting body for generating a voltage signal in response to movement of a portion of the connecting body according to the ultrasonic vibrations; and
at least one light source substantially proximate to the tip, said at least one light source being connected to and receiving the voltage signal from the second transducer to generate light.

2. The ultrasonic dental insert of claim 1, wherein the second transducer comprises a coil surrounding said portion of the connecting body.

3. The ultrasonic dental insert of claim 2, wherein said at least one light source is an LED connected between a first end of the coil and a second end of the coil.

4. The ultrasonic dental insert of claim 2, further comprising a hand grip enveloping at least said portion of the connecting body.

5. The ultrasonic dental insert of claim 4, wherein the coil is at least partially disposed within the hand grip.

6. The ultrasonic dental insert of claim 5, further comprising a bobbin at least partially disposed within the hand grip in a surrounding relationship with said portion of the connecting body, wherein the coil and said at least one light source are mounted on the bobbin.

7. The ultrasonic dental insert of claim 1, wherein the first transducer comprises a stack of nickel plates.

8. The ultrasonic dental insert of claim 1, wherein the tip is removably attached to the distal end of the connecting body, such that the tip can be replaced by another tip.

9. The ultrasonic dental insert of claim 1, wherein the tip is removably attached to the distal end.

10. The ultrasonic dental insert of claim 9, wherein the removable tip comprises metal, plastic, or a combination thereof.

11. The ultrasonic dental insert of claim 6, further comprising a retaining tube secured onto the connecting body, wherein the bobbin is fixedly attached to the retaining tube.

12. A method of generating light used during dental procedures, comprising:
generating ultrasonic vibrations using a first transducer attached to a proximal end of a connecting body having the proximal end and a distal end having a tip attached thereto;
transmitting the ultrasonic vibrations through the connecting body toward the tip attached to the distal end of the connecting body;
generating a voltage signal using a second transducer disposed substantially proximate to the connecting body in response to movement of a portion of the connecting body according to the ultrasonic vibrations; and
emitting the light from at least one light source substantially proximate to the tip and connected to the second transducer using the voltage signal.

13. The method of claim 12, wherein said emitting comprises emitting the light from said at least one light source connected to a coil surrounding said portion of the connecting body.

14. The method of claim 13, wherein said emitting comprises emitting the light from an LED connected between a first end of the coil and a second end of the coil.

15. An ultrasonic dental tool comprising:
an ultrasonic dental insert including:
a first transducer for generating ultrasonic vibrations;
a connecting body having a proximal end and a distal end having a tip attached thereto, the proximal end attached to the first transducer so as to receive the ultrasonic vibrations therefrom and to transmit the ultrasonic vibrations toward the tip attached to the distal end;
a second transducer disposed substantially proximate to the connecting body for generating a voltage signal in response to a movement of a portion of the connecting body according to the ultrasonic vibrations; and
at least one light source substantially proximate to the tip, said at least one light source being connected to and receiving the voltage signal from the second transducer to generate light; and
a handpiece for holding the ultrasonic dental insert and for providing electromagnetic energy to the first transducer to generate the ultrasonic vibrations.

16. A method of illuminating a work region comprising:
receiving mechanical energy at a generator, said generator being mechanically supported by a tool handle, said tool handle being adapted to support an ultrasonic tool tip;
converting said mechanical energy to electromagnetic energy; and illuminating a work region using at least a portion of said electromagnetic energy.

17. A method of illuminating a work region as defined in claim 16 wherein said receiving mechanical energy at a generator comprises:
receiving electrical energy at an input of an electromagnetic transducer;
forming a magnetic field within said electromagnetic transducer;
moving an electromechanical transducer using said magnetic field; and
moving an input member of said generator with said electromechanical transducer, whereby said generator receives said mechanical energy.

18. A method of illuminating a work region as defined in claim 17 wherein said moving an input member of said generator comprises reciprocating said input member at a frequency of from about 25 kHz to about 30 kHz.

19. A method of illuminating a work region as defined in claim 16 wherein said converting said mechanical energy to electromagnetic energy comprises: moving a magnetized member past an electrical coil.

20. A method of illuminating a work region as defined in claim 19 wherein said electrical coil comprises at least one helically-wound electrical conductor.

21. A method of illuminating a work region as defined in claim 19 wherein said moving a magnetized member comprises rotating said magnetized member about a rotational axis.

22. A method of illuminating a work region as defined in claim 16 wherein said converting said mechanical energy to electromagnetic energy comprises: generating an electrical signal using said generator; receiving said electrical signal through an electrical conductor at an input of a light source; and emitting visible light from said light source.

23. A method of illuminating a work region as defined in claim 22 wherein said light source is selected from a group consisting of a light emitting diode, and an incandescent lamp.

24. A method of illuminating a work region as defined in claim 16 wherein said generator is disposed within said tool handle.

25. A method of illuminating a work region as defined in claim 16 further comprising: performing a dental procedure with said tool handle including contacting a tooth with said ultrasonic tool tip, said ultrasonic tool tip being mechanically coupled to said tool handle, such that a surface of said tooth is disposed within said work region.

26. A method of cleaning a tooth surface comprising: receiving an ultrasonic signal at a dental tool handpiece; converting said ultrasonic signal to an ultrasonic motion of a connecting body supporting a dental tool tip; coupling said ultrasonic motion of said connecting body to an electrical generator; generating electrical current with said electrical generator; energizing at least one light source with said electrical current; contacting said dental tool tip to a surface of a tooth; and illuminating said surface of a tooth adjacent said dental tool tip with said light source.

27. A method of cleaning a tooth surface as defined in claim 26 wherein said converting said ultrasonic signal to ultrasonic motion of a dental tool tip comprises generating a magnetic field using said ultrasonic signal, and applying the magnetic field to a magnetostrictive transducer and responsively oscillating said magnetostrictive transducer at a frequency related to said ultrasonic signal.

28. A method of cleaning a tooth surface as defined in claim 27 wherein said coupling said ultrasonic motion of said dental tool tip to an electrical generator comprises mechanically coupling said magnetostrictive transducer to the connecting body and mechanically coupling said connecting body to said dental tool tip.

29. A method of cleaning a tooth surface as defined in claim 26 wherein said generating an electrical current with said electrical generator comprises: oscillating a magnetized member adjacent a helical arrangement of electrical conductors.

30. A dental tool comprising: means for applying mechanical energy to a support member; means for applying a first portion of said mechanical energy to a work surface; means for converting a second portion of said mechanical energy to electrical energy; and means for converting at least a portion of said electrical energy to visible light.

31. A dental tool as defined in claim 30 wherein said means for converting a second portion of said mechanical energy to electrical energy comprises an electromagnetic generator.

32. A dental tool as defined in claim 30 wherein said means for converting at least a portion of said electrical energy to visible light comprises a light emitting diode.

33. A dental tool as defined in claim 30 wherein said means for converting at least a portion of said electrical energy to visible light comprises an incandescent lamp.

34. A dental tool as defined in claim 33 wherein said incandescent lamp comprises a halogen light bulb.

35. A dental tool as defined in claim 30 wherein said means for applying a first portion of said mechanical energy to a work surface comprises a dental tool tip.
